(19) United States
(12) Patent Application Publication
(10) Pub. No.: US 2007/0260835 A1
(43) Pub. Date: Nov. 8, 2007

(54) Storage controlling device of disk array device and redundancy restoring method

(75) Inventor: Kazuma Takatsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/826,453

(22) Filed: Jul. 16, 2007

Related U.S. Application Data
(63) Continuation of application No. PCT/JP05/01857, filed on Feb. 8, 2005.

(51) Int. Cl. G06F 12/16

(52) U.S. Cl. 711/162

(57) ABSTRACT

A storage controlling device controlling a storage device having a secondary storage unit for backup and a primary storage unit including a plurality of storing units in a redundant configuration, comprises a unit determining whether a storing unit not in a redundant configuration exists within the primary storage unit and a unit disassembling one of the storing units in a redundant configuration within the primary storage unit, the data of the one of the storing units being saved in the secondary storage unit for backup, and executing a rebuilding process for a storing unit for which a degradation process has been executed by using the disassembled storing unit if the storing unit that is within the primary storage unit and for which the degradation process has been executed holds the latest data, and if the storing unit not in a redundant configuration does not exist within the primary storage unit.

### CROSS REFERENCE TO RELATED APPLICATION

This application is a continuation of international PCT application No. PCT/JP2005/001857 filed on Feb. 8, 2005.

### BACKGROUND OF THE INVENTION

1. Field of the Invention

The present invention relates to a storage controlling device (controller) of a disk array device and a redundancy restoring method executed by the controller.

2. Description of the Related Art

A disk array device for which a redundant configuration is adopted exists in order to be able to cope with disk faults. In such a disk array device, a way to restore redundancy when a disk fault occurs is often an issue.

For example, Patent Document 1 following discloses a technique for restoring redundancy when a disk fault occurs in a disk array device for which mirroring is adopted as a redundant configuration. According to the technique, when a disk fault occurs, a disk group is identified, on the basis of priority information that is held in a mirroring management table and set for each disk, that forms a mirroring pair to be dissolved. Then, a new mirroring pair is formed by pairing one disk included in the disk group that dissolved the pair with one disk that has been paired with a disk in which the fault has occurred.

Additionally, Patent Document 2 following discloses a technique for restoring redundancy by fetching a fault substitutive device from another group having high redundancy without performing a hot spare patrol.

Patent Document 1: Japanese Published Unexamined Patent Application No. H9-269871 “Data Re-redundancy Making System in Disk Array Device”

Patent Document 2: Japanese Published Unexamined Patent Application No. H10-260789 “Device Array System”

A disk array device that comprises a disk array for which a redundant configuration is adopted and that can access storage for backup exists in addition to the above described devices. In such a device, if disk degradation occurs in a disk within the disk array device when an empty hot spare does not exist, the non-redundant state of a disk/disks forming the disk array in conjunction with the disk in which the disk degradation occurs continues until the degraded disk is replaced, leading to an increased possibility that user data will be lost.

### SUMMARY OF THE INVENTION

An object of the present invention is to provide a controller for a disk array device and to provide a redundancy restoring method that can make non-redundant data redundant at an early stage even if disk degradation occurs in a disk within the disk array device when an empty hot spare does not exist.

A storage controlling device according to a first aspect of the present invention is a storage controlling device controlling a storage device having a secondary storage unit for backup and having a primary storage unit that has a plurality of storing units for which a redundant configuration is adopted. This storage controlling device comprises a unit determining whether or not a storing unit in a state of not being in a redundant configuration exists within the primary storage unit, and a unit disassembling one of the storing units in a redundant configuration within the primary storage unit, the data of said one of the storing units being saved in the secondary storage unit for backup, and executing a rebuilding process for a storing unit for which a degradation process has been executed by using the disassembled storing unit if the storing unit that is within the primary storage unit and for which the degradation process has been executed holds the latest data and if the storing unit in the state of not being in a redundant configuration does not exist within the primary storage unit.

Here, a storing unit for which the data is saved in the secondary storage unit for backup and that is in a redundant configuration within the primary storage unit is disassembled (disk pair or RAID is disassembled) and allocated to a degraded disk as a new hot spare if a storing unit (empty hot spare) in a state of not being in a redundant configuration does not exist within the primary storage unit and if the storing unit (disk) that is within the primary storage unit and for which the degradation process has been executed holds the latest data. Accordingly, if a fault occurs in a disk that holds the latest data when an empty hot spare does not exist, non-redundant data can be made redundant at an early stage, whereby the possibility that data will be lost can be decreased.

A storage controlling device according to a second aspect of the present invention is a storage controlling device controlling a storage device that has a primary storage unit having a plurality of mirrored storing units, and that has a secondary storage unit and a spare storage unit. This storage controlling device comprises a first determining unit determining whether or not the spare storage unit exists, a second determining unit determining whether or not data stored in a storing unit that constitutes the primary storage unit is equivalent to data stored in the secondary storage unit, and a processing unit executing a rebuilding process for a degraded storing unit by using the spare storage unit if the first determining unit determines that the spare storage unit exists when the storing unit that constitutes the primary storage unit is degraded; and canceling mirroring of a storing unit, the entire stored data of which is determined by the second determining unit to be equivalent to the data stored in the secondary storage unit, and executing a rebuilding process for the degraded storing unit by using the storing unit for which the mirroring has been canceled if the first determining unit determines that the spare storage unit does not exist when the storing unit that constitutes the primary storage unit is degraded.

It is obvious that operations and effects similar to those resulting when using the storage controlling device can also be implemented with a redundancy restoring method executed by the storage controlling device according to each aspect of the present invention, or with a program for causing the storage controlling device according to each aspect to execute a redundancy restoring process.

According to the present invention, non-redundant data can be made redundant at an early stage if degradation occurs in a disk that holds the latest data when an empty hot spare does not exist, whereby the possibility that data will be lost can be reduced.

### BRIEF DESCRIPTION OF THE DRAWINGS

FIG. 1 is a schematic showing the outline of a configuration of an entire system including a disk array device according to a preferred embodiment of the present invention;

FIG. 2 is a schematic showing the allocation of the primary storage to a virtual volume (VLU);

FIG. 3 is a block diagram showing details of the configuration of the entire system including the disk array device according to the preferred embodiment of the present invention;

FIG. 4 is a schematic showing the data structure of an MRB block;

FIG. 5 is a schematic showing one example of a correspondence between a virtual volume (VLU) viewed from a host and a volume (OLU) managed within primary storage;

FIG. 6 is a schematic explaining a data flow between the primary storage and the secondary storage in correspondence with a transmission/reception request from the host;

FIG. 7 is a flowchart showing a process executed on the disk array device side in correspondence with the transmission/reception request from the host;

FIG. 8 is a flowchart showing a process executed when disk degradation occurs within the disk array device;

FIG. 9 is a schematic showing mirroring before disk degradation and mirroring after disk degradation;

FIG. 10 is a schematic showing the hardware environment of this preferred embodiment; and

FIG. 11 is a schematic exemplifying storage media.

### DESCRIPTION OF THE PREFERRED EMBODIMENTS

A preferred embodiment according to the present invention is described in detail below with reference to the drawings.

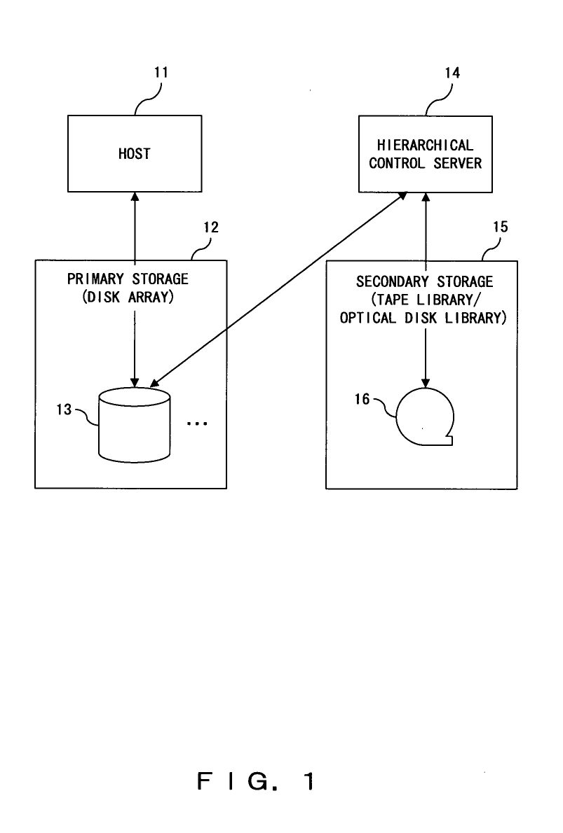

FIG. 1 is a schematic showing the outline of the configuration of an entire system including a disk array device according to a preferred embodiment of the present invention.

As shown in FIG. 1, a storage device is configured with a unit (disk array device) 12 for controlling primary storage (disk array) 13 in the form of an array to which fast access can be made and which has a high cost per capacity, a unit 15 for controlling secondary storage (tape library, optical disk library) 16 that has a cheaper cost per capacity but has a slower access speed than that of the primary storage 13, and a hierarchical control server 14 as an interface between the units. This storage device executes necessary processes; for example, it can execute a process in correspondence with a transmission/reception request (read/write instruction) from a host 11.

In the configuration shown in FIG. 1, the host 11 recognizes the capacity of the secondary storage 16 as a virtual volume (Virtual Logical Unit, VLU) and makes a data transmission/reception to/from the secondary storage 16 via the primary storage unit 12.

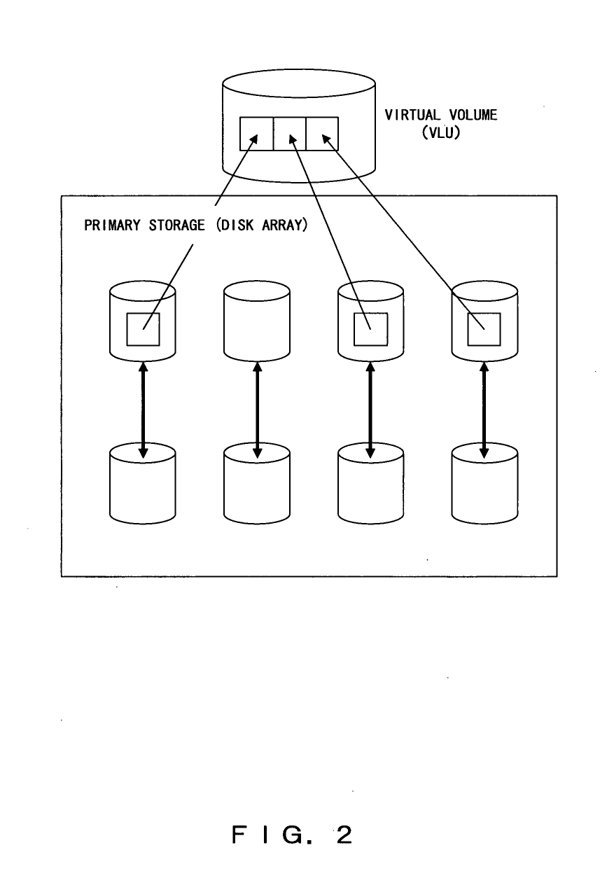

As the transmission/reception process proceeds between the host 11 and the storage device, some of the disk regions of the primary storage 13 will be allocated to the VLU by the primary storage unit 12, as shown in FIG. 2. In this preferred embodiment, mirroring is adopted as a redundant configuration on the primary storage side, as shown in FIG. 2.

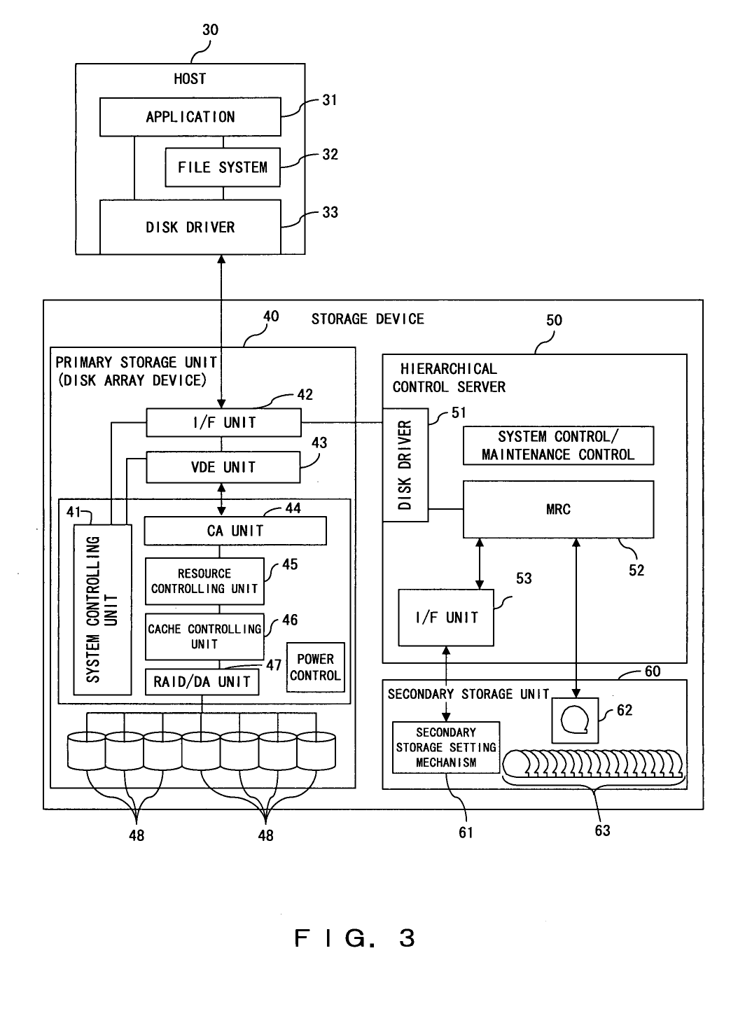

FIG. 3 is a block diagram showing the details of the configuration of the entire system, including the disk array device according to the preferred embodiment of the present invention.

In FIG. 3, a host 30 comprises an application 31, a file system 32, and a disk driver 33. For example, an instruction to read a file or an instruction to write to a file is issued by a user with the application 31 of the host 30, and the instruction is transmitted to the storage device side via the file system 32 and the disk driver 33.

A storage device is configured with a primary storage unit (disk array device) 40, a hierarchical control server 50, and a secondary storage unit 60.

The primary storage unit 40 is configured with primary storage (disk array) 48 in the form of an array and a controller for controlling and maintaining the primary storage 48.

The controller is configured with a system controlling unit 41 for performing a component degradation process, a system state transition control or other processes, an I/F unit 42 that is an interface with the host 30 and the hierarchical control server 50, a VDE (Virtual Disk Engine) unit 43 for managing mapping information of the disk space of the virtual disk (VLU) and the disk space of a real disk (OLU) and for issuing a “recall” request, “Sync” request, etc. to the MRC of the hierarchical control server, a CA (Channel Adapter) unit 44 for executing a process similar to the I/F unit 42 on the basis of a processing request that the VDE unit converts from a virtual disk to a real disk, a resource controlling unit 45 for managing the resources of the primary storage (e.g., managing shared control table, controlling the host accesses exclusively, etc.), a cache controlling unit 46 for managing the cache memory (whether or not specified data exists in the cache memory) of the primary storage, and a RAID/DA (Device Adapter) unit 47 for controlling an I/F between disks of the primary storage.

The hierarchical control server 50 is configured with a disk driver 51, a migration/recall controller (MRC) 52 for performing a migration/recall or other such process, and an I/F unit 53 that is an interface between a secondary storage setting mechanism 61 and the MRC 52.

The secondary storage unit 60 is configured with secondary storage 63 for backup, a driving device 62 for the secondary storage 63, and a secondary storage setting mechanism 61 for setting/removing the secondary storage 63 in/from the driving device 62.

The primary storage unit (disk array device) manages, by using a mapping management table, the state of data; for example, it manages whether or not data instructed from the host exists and in which portion of the primary storage the data exists if it exists. The mapping management table is configured with a plurality of blocks called migration recall blocks (MRBs). The migration indicates an operation for writing data of the primary storage to the secondary storage, whereas the recall indicates an operation for reading data of the secondary storage into the primary storage.

As described above, a storage controlling device according to a first aspect of the present invention is a storage controlling device controlling a storage device having a secondary storage unit for backup and having a primary storage unit that has a plurality of storing units for which a redundant configuration is adopted. Also as described above, this storage controlling device comprises a unit determining whether or not a storing unit in a state of not being in a redundant configuration exists within the primary storage unit, and a unit disassembling one of the storing units in a redundant configuration within the primary storage unit, the data of the one of the storing units being saved in the secondary storage unit for backup, and executing a rebuilding process for a storing unit for which a degradation process has been executed by using the disassembled storing unit if the storing unit that is within the primary storage unit and for which the degradation process has been executed holds the latest data and if the storing unit in the state of not being in a redundant configuration does not exist within the primary storage unit. The execution of the degradation process and the determination of the storing unit that is not in a redundant configuration correspond to part of the function of a system controlling unit 41 (shown in FIG. 3), for example. The disassembly of the storing unit corresponds to part of the function of the system controlling unit 41 of FIG. 3, for example. The execution of rebuilding corresponds to a RAID/DA unit 47 (shown in FIG. 3), for example.

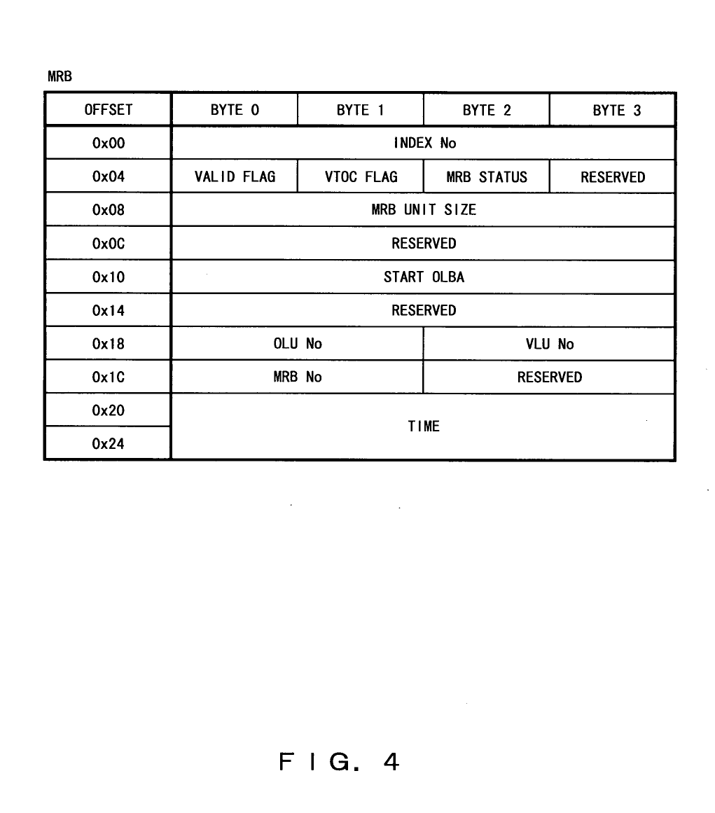

FIG. 4 is a schematic showing the data structure of an MRB block.

The meanings of the fields in FIG. 4 are as follows.

Index No: A serial number for all MRBs.

Valid Flag: A flag indicating whether or not a block is used.

VTOC Flag: A flag indicating whether or not the block is allocated to a VTOC data region.

MRB Status: Indicates the state of data managed by the block. In this field, the values of Miss, Hit, or Dirty can be set. The meanings of the respective values are as follows.

Dirty: Data is being updated in the primary storage (the primary storage holds the latest data, and data of the primary storage and that of the secondary storage are not equal).

Hit: Data of the primary storage and that of the secondary storage are equal.

Miss: Data is not allocated to the primary storage and is held in the secondary storage.

MRB Unit Size: The size (unit: Logical Block Address, LBA) of data of the primary storage, which is managed by the block.

OLU No: The number of the OLU (Open Logical Unit) of the primary storage, for which allocation is managed by the block.

VLU No: The number of the VLU for which allocation is managed by the block.

Start OLBA: The starting LBA of the OLU in the primary storage, for which allocation is managed by the block.

MRB No: A field indicating the number of the block from the beginning in the VLU.

Time: The time at which the last access is made to the data managed by the block.

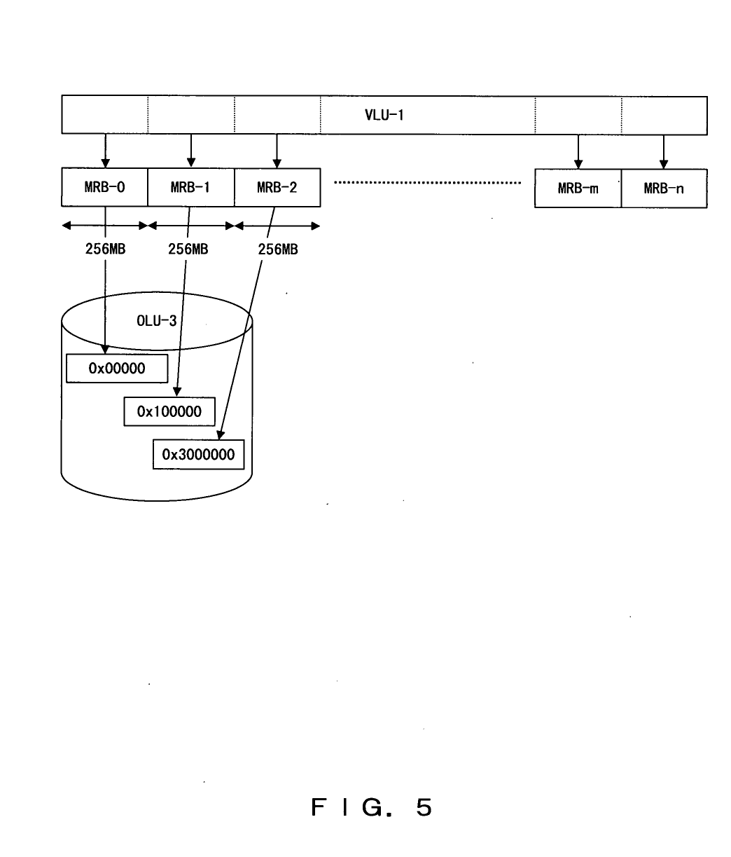

FIG. 5 is a schematic showing one example of a correspondence between a virtual volume (VLU) viewed from the host and a volume (OLU) managed within the primary storage.

In the example shown in FIG. 5, 256 MB is set as the data size of the primary storage, which is the data size managed by one MRB block. Considering that 1LBA=512 bytes, one MRB block manages data in units of LBAs of 256 MB/512 bytes=524288. For example, MRB-0 manages 0˜524287 of VLULBA, and MRB-1 manages 524288˜1048575. 0˜n of MRB-0˜MRB-n are values set in the field of Index No in FIG. 4.

Additionally, in this figure, the starting LBAs (Start OLBA of FIG. 4) of the OLUs in the primary storage for MRB-0, MRB-1, and MRB-2 are given as “0×00000”, “0×100000”, and “0×3000000”, respectively.

Operations of the disk array device according to this preferred embodiment are described below. Namely, a process that is executed on the disk array device side when the disk array device receives a transmission/reception request from the host, which is the request that becomes a trigger changing the state (Dirty, Hit, or Miss) of data within the MRB block, is initially described, and a redundancy restoring process when disk degradation occurs within the disk array device, which is executed by referencing such a state of the data in the MRB block, is described next.

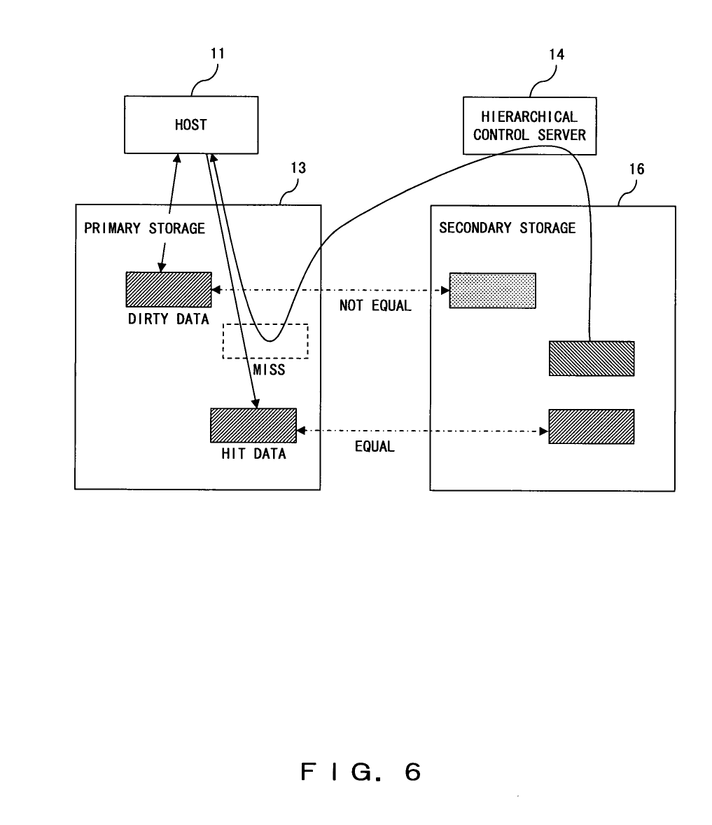

FIG. 6 is a schematic explaining a data flow between the primary storage and the secondary storage in correspondence with a transmission/reception request from the host.

As described above, the transmission/reception request from the host 11 is firstly received by the primary storage unit (disk array device). The above described Dirty, Hit, and Miss exist as the state of data within the primary storage 13, which is managed by the primary storage unit.

In FIG. 6, for example, if the transmission/reception request (read/write instruction) for data in the Miss state in the primary storage 13 is received from the host 11, a transmission/reception process for the data is executed between the host 11 and the primary storage 13 after corresponding data is read from the secondary storage 16 into any of the regions of the primary storage 13.

Additionally, if a transmission/reception request (read/write instruction) for data in the Dirty state in the primary storage 13 is received from the host 11, for example, a transmission/reception process for the data is executed between the host 11 and the primary storage 13.

Furthermore, if a transmission/reception request (read/write instruction) for data in the Hit state in the primary storage 13 is received from the host 11, for example, a transmission/reception process for the data is executed between the host 11 and the primary storage 13.

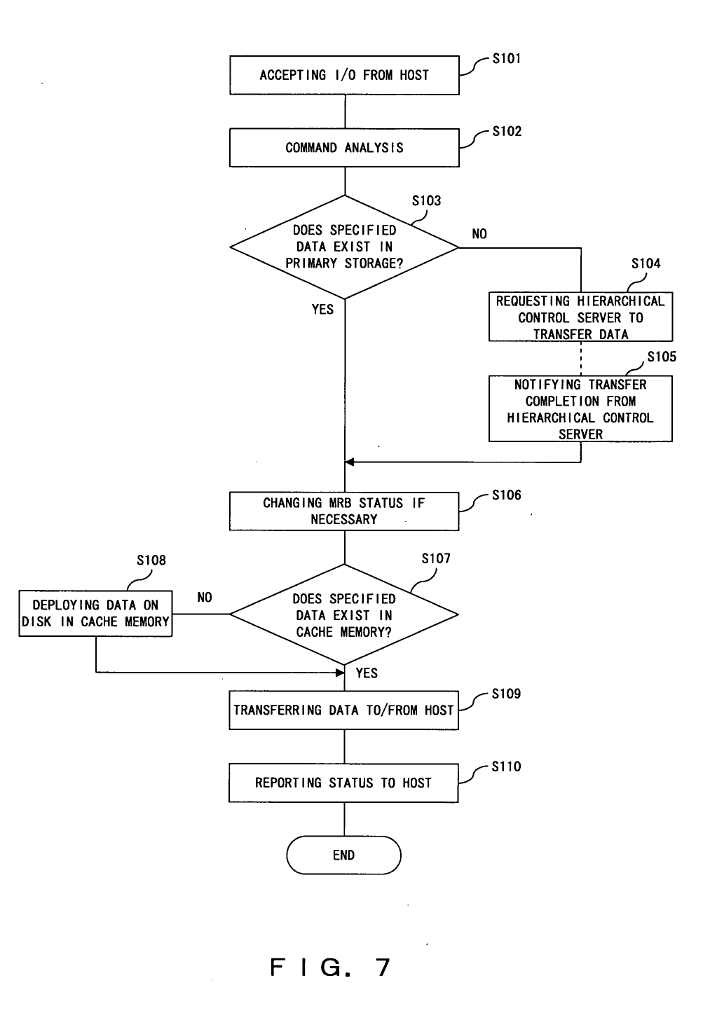

FIG. 7 is a flowchart showing a process executed on the primary storage unit (disk array device) side in correspondence with a transmission/reception request from the host.

Initially in FIG. 7, in step S101, the I/F unit 42 of the primary storage unit accepts an I/O (i.e., a transmission/reception request, or a read/write instruction) from the host. The I/F unit 42 passes the accepted transmission/reception request to the VDE unit 43. Then, in step S102, a command analysis is made by the VDE unit 43 to which the transmission/reception request from the host is passed. With the command analysis, a read/write starting position, the length of data, and whether the request is a request to read into the host or to write to the secondary storage are set by referencing corresponding information within the transmission/reception request.

Then, in step S103, whether or not data (specified data) targeted by the transmission/reception request exists in the primary storage is determined by searching MRB blocks with the use of a VLU number (VLU No. in FIG. 4) and the VLU_LBA (the read/write starting position instructed from the host) both specified within the transmission/reception request as keys. If it is determined that the specified data does not exist in the primary storage, a data transfer request is made from the VDE unit 43 to the MRC 52 of the hierarchical control server 50 in step S104. Upon completion of the transfer process requested in step S104, the completion of the transfer is reported to the VDE unit 43 by the MRC 52 in step S105, and the flow proceeds to step S106. Or, if the specified data is determined to exist in the primary storage in step S103, the flow immediately proceeds to step S106.

In step S106, the VDE unit 43 changes the state of an MRB depending on need. For example, if a data transfer is made from the secondary storage for an MRB in the Miss state, the state of the MRB is changed to Hit upon completion of the data transfer.

Then, in step S107, whether or not the specified data exists in the cache memory is determined by the cache controlling unit 46. If the specified data is determined to not exist in the cache memory, the data on the disk is deployed in the cache memory by the RAID/DA unit 47 in step S108, and the flow proceeds to step S109. Or, if the specified data is determined to exist in the cache memory in step S107, the flow immediately proceeds to step S109.

In step S109, the data transfer process is executed between the host and the primary storage unit itself. Namely, if the instruction from the host is a read instruction, the data is transferred to the host. If the instruction from the host is a write instruction, the data is transferred from the host to the disk array device side.

Then, in step S110, whether or not the read/write instruction is properly executed is reported to the host, and the series of processes is terminated.

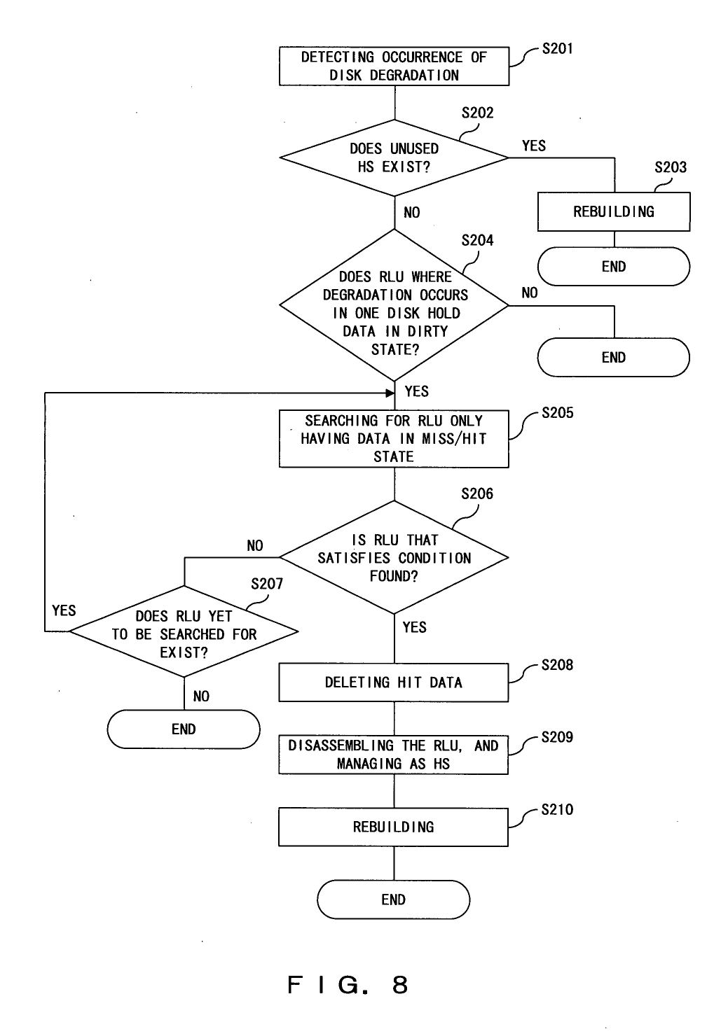

FIG. 8 is a flowchart showing a process executed when disk degradation occurs within the primary storage unit (disk array device).

Namely, in step S201, this series of processes is started by being triggered by a degradation process executed by the system controlling unit 41 for a faulty disk.

Then, in step S202, whether or not an unused hot spare exists is determined by the system controlling unit 41 by referencing the disk configuration information. If the unused hot spare exists, in step S203, the RAID/DA unit 47 rebuilds an RLU (RAID Logical Unit) where degradation occurs in one disk by using the hot spare, and the series of processes is terminated. The RLU indicates a disk group in a state of being grouped to form a RAID. A plurality of MRBs are allocated to the RLU.

Alternately, if the unused hot spare is determined to not exist in step S202, the VDE unit 43 determines whether or not the RLU where degradation occurs in one disk holds data in the Dirty state by referencing the states (MRB status of FIG. 4) of the plurality of MRBs allocated to the RLU in step S204.

If the RLU where degradation occurs in one disk is determined not to hold the data in the Dirty state in step S204, the series of processes is terminated. Or, if the RLU where degradation occurs in one disk is determined to hold the data in the Dirty state, the VDE unit 43 searches for whether or not an RLU only having data in the Miss or the Hit state exists by referencing the states (MRB Status of FIG. 4) of a plurality of MRBs allocated to respective RLUs in step S205.

Then, in step S206, the VDE unit 43 determines whether or not an RLU that satisfies the condition, namely, an RLU to which only MRBs in the Miss or Hit state are allocated, is found. If the corresponding RLU is determined to not be found, whether or not an RLU yet to be searched for exists is determined in step S207. If the RLU yet to be searched for does not exist, namely, if all of the RLUs have been searched for, the series of processes is terminated.

Or, if the RLU yet to be searched for exists, the flow returns to step S205.

If an RLU that satisfies the condition is determined to be found in step S206, the VDE unit 43 deletes the Hit data of the RLU in step S208. Namely, the values of the fields other than the Index No. of the MRB blocks are initialized. Then, in step S209, the system controlling unit 41 changes the disk configuration information so that the RLU is disassembled and managed as a hot spare. Then, in step S210, the RAID/DA unit 47 rebuilds the RLU where degradation occurs in one disk by using the hot spare obtained in step S209, and the series of processes is terminated.

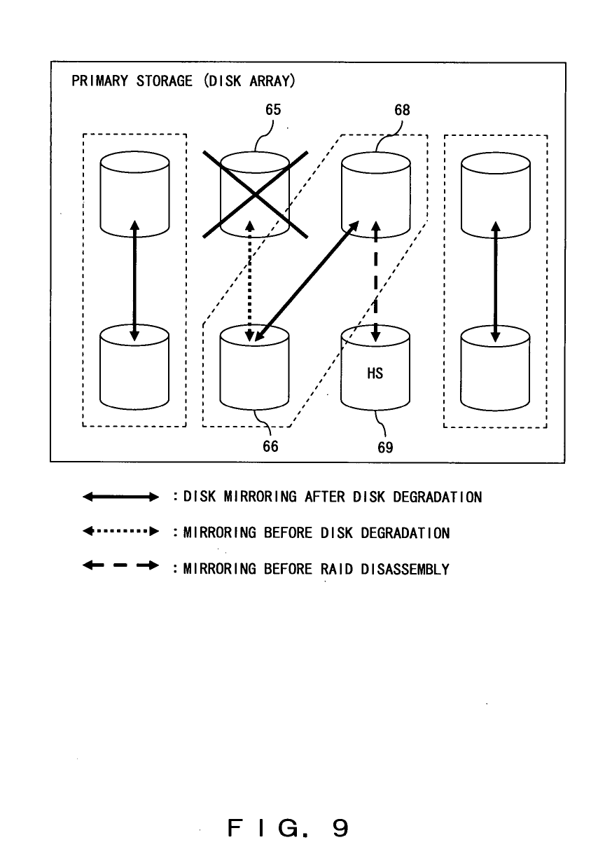

FIG. 9 is a schematic showing mirroring before disk degradation and mirroring after disk degradation.

In FIG. 9, disks 65 and 66 and disks 68 and 69 are paired respectively as RAIDs in the disk array within the disk array device (mirroring is adopted as a redundant configuration). If degradation occurs in disk 65 and this disk holds data in the Dirty state when an empty hot spare does not exist within the disk, a disk group (disks 68 and 69) holding only data in the Miss or the Hit state is identified as a search result. Then, the identified disk group is disassembled, one of the disks belonging to the disk group is rebuilt (disk 68 for this example), and disks 66 and 68 are paired as a RAID.

As described above, in this preferred embodiment, if an empty hot spare does not exist and if disk degradation occurs in an RLU that holds data in the Dirty state, a RAID having only Hit data is disassembled and allocated as a new hot spare to the RLU in which degradation occurs in one disk. Therefore, if disk degradation occurs in an RLU that holds data in the Dirty state when an empty hot spare does not exist, non-redundant data can be made redundant at an early stage, leading to a decrease in the possibility that data will be lost.

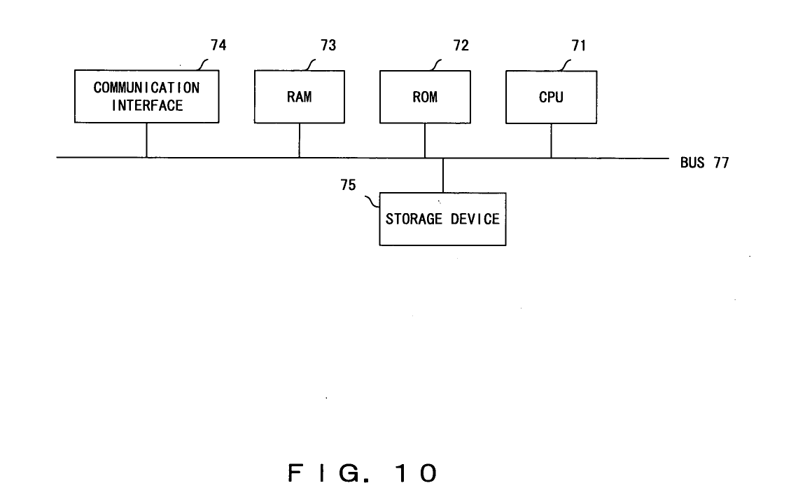

The redundancy restoring process for a disk in which degradation occurs according to this preferred embodiment can be configured as software. FIG. 10 is a schematic showing a hardware environment when this preferred embodiment is implemented as a program.

In FIG. 10, a computer (disk array device) as hardware is configured with a CPU 71, ROM 72, RAM 73, a communication interface 74, and a storage device 75, all of which are interconnected by a bus 77.

In FIG. 10, the CPU 71 controls the entire computer, and, a program such as a program for implementing the processes of the units within the disk array device 40 of FIG. 3 is executed in the RAM 73. The program for implementing the processes of the units is stored in the ROM 72 or the storage device 75. The program and data are exchanged with another device via the communication interface 74.

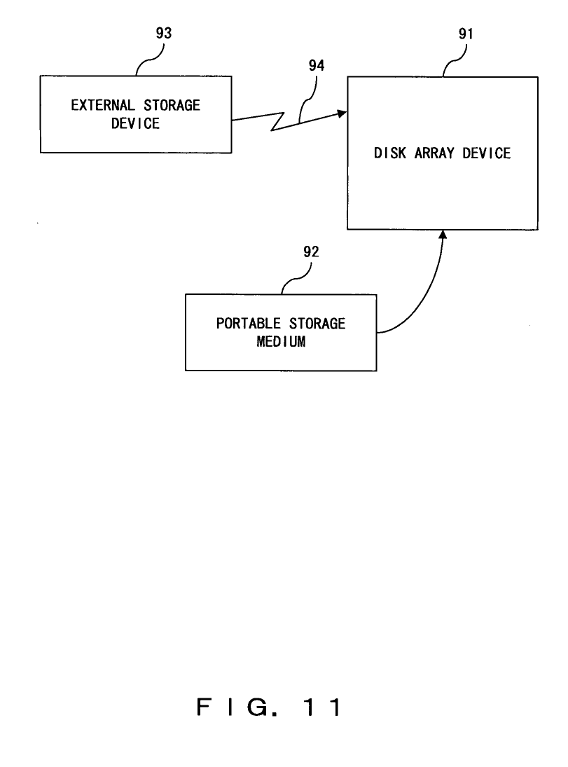

FIG. 11 is a schematic explaining the loading of the program.

The program according to the present invention for executing the redundancy restoring process for a disk in which degradation occurs can be executed by being loaded into the memory of the disk array device 91 from the ROM or the storage device within the disk array device 91, by being loaded into the memory of the disk array device 91 from a portable storage medium 92, or by being loaded into the memory of the disk array device 91 from an external storage device 93 via a network 94.

The above description adopts mirroring as the redundant configuration of the disk array device. However, other redundancy configurations can be adopted.

What is claimed is:

1. A storage controlling device controlling a storage device having a secondary storage unit for backup and having a primary storage unit that has a plurality of storing units for which a redundant configuration is adopted, comprising:
a unit determining whether or not a storing unit in a state of not being in a redundant configuration exists within the primary storage unit; and
a unit disassembling one of the storing units in a redundant configuration within the primary storage unit, the data of said one of the storing units being saved in the secondary storage unit for backup, and executing a rebuilding process for a storing unit for which a degradation process has been executed by using the disassembled storing unit if the storing unit that is within the primary storage unit and for which the degradation process has been executed holds the latest data and if the storing unit in the state of not being in a redundant configuration does not exist within the primary storage unit.

2. A disk array device that has a primary storage unit having a plurality of storing units for which a redundant configuration is adopted and that can access a secondary storage unit for backup, comprising:
a unit determining whether or not a storing unit in a state of not being in a redundant configuration exists within the primary storage unit; and
a unit disassembling one of the storing units in a redundant configuration within the primary storage unit, the data of said one of the storing units being saved in the secondary storage unit for backup, and executing a rebuilding process for a storing unit for which a degradation process has been executed by using the disassembled storing unit if the storing unit that is within the primary storage unit and for which the degradation process has been executed holds the latest data and if the storing unit in the state of not being in a redundant configuration does not exist within the primary storage unit.

3. A redundancy restoring method that is executed by a storage controlling device controlling a storage device having a secondary storage unit for backup and having a primary storage unit that has a plurality of storing units for which a redundant configuration is adopted, comprising:
determining whether or not a storing unit in a state of not being in a redundant configuration exists within the primary storage unit; and
disassembling one of the storing units in a redundant configuration within the primary storage unit, the data of said one of the storing units being saved in the secondary storage unit for backup, and executing a rebuilding process for a storing unit for which a degradation process has been executed by using the disassembled storing unit if the storing unit that is within the primary storage unit and for which the degradation process has been executed holds the latest data and if the storing unit in the state of not being in a redundant configuration does not exist within the primary storage unit.
